(19) United States
(12) Patent Application Publication
(10) Pub. No.: US 2025/0261575 A1
(43) Pub. Date: Aug. 21, 2025

(54) PATH PLANNING

(71) Applicant: Deere & Company, Moline, IL (US)

(72) Inventors: Andrew M. COLOSKY, Urbandale, IA (US); Marlon W. BRIGHT, West Des Moines, IA (US); Bryan R. YANKE, Eldridge, IA (US); Cody M. SORGE, Davenport, IA (US)

(73) Assignee: Deere & Company, Moline, IL (US)

(21) Appl. No.: 18/581,797

(22) Filed: Feb. 20, 2024

(51) Int. Cl. A01B 69/04; A01C 21/00; A01M 7/00; G05D 1/644; G05D 1/667; G05D 105/15; G05D 107/20

(52) U.S. Cl. CPC A01B 69/008; A01M 7/0089; G05D 1/644; G05D 1/667; A01C 21/005; G05D 2105/15; G05D 2107/21

(57) ABSTRACT

A path planning system and technique automatically plans an agricultural operation performed by an agricultural machine based on various inputs. Based on acquired input data, a plurality of potential plans or paths for the agricultural operation are generated. The plurality of plans are evaluated based on a set of considerations and scored. A ranking based on scores facilitates automatic selected of a final plan for the agricultural operation. The system communicates the final plan and/or instructions based on the final plan to coordinate execution of the agricultural operation among several entities.

### BACKGROUND

Various agricultural operations performed in a field may involve tendering operations or another handover of material. For instance, for an agricultural operation where products are applied, tendering operations may be performed to refill an agricultural machine or vehicle with the products. For a harvesting operation, in another example, the agricultural machine or vehicle may become full with harvested crop, which is transitioned to a transport vehicle. Locations near the field where such operations occur during the agricultural operation may be planned.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a system for an agricultural machine is provided. The system includes at least one processor and a memory that stores instructions. The instructions, when executed by the at least one processor, configure the at least one processor to: acquire input data related to an agricultural operation; generate plan data indicative of a plurality of potential plans for the agricultural machine to perform the agricultural operation; evaluate plan data for each potential plan of the plurality of plans and generate score data; select a final plan from the plurality of potential plans based at least in part on the score data; and communicate final plan data indicative of the final plan to at least the agricultural machine.

In another implementation, a system for performing an agricultural operation is provided. The system include an agricultural machine configured to perform the agricultural operation. The system further includes at least one processor configured to: receive input data indicative of at least one of a configuration of the agricultural machine, field attributes for a field where the agricultural operation is performed, prior operations performed on the field, product information for the agricultural operation, or tender operation attributes; generate a plurality of potential plans for the agricultural operation based at least in part on the input data; select a final plan from the plurality of potential plans based on an evaluation of a set of features for each potential plan; and communicate the final plan to the agricultural machine. The agricultural machine provides guidance information to an operator based on the final plan.

In yet another implementation, a method for generating a plan for an agricultural operation is provided. The method includes acquiring, by at least one processor, one or more inputs for the agricultural operation. The inputs include one or more of a tender cycle time, a prescription, a machine configuration, or field attributes. The method also includes generating a plurality of potential paths for an agricultural machine to carry out the agricultural operation. The method further includes evaluating the plurality of potentials paths to select a proposed plan. In addition, the method includes communicating the proposed plan to at least the agricultural machine.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

Various non-limiting embodiments are further described in the detailed description given below with reference the accompanying drawings, which are incorporated in and constitute a part of the specification.

FIG. 1 illustrates a schematic diagram of an exemplary, non-limiting implementation of a planning system for an agricultural operation according to various aspects.

FIG. 2 illustrates a block diagram of an exemplary, non-limiting implementation of a computing device configured to plan an agricultural operation according to various aspects.

FIG. 3 illustrates a schematic diagram of an exemplary, non-limiting implementation for a planning module in accordance with various aspects.

FIG. 4 illustrates a schematic diagram of a non-limiting example of a planning operation according to various aspects.

FIG. 5 illustrates a flow chart of an exemplary, non-limiting implementation for planning an agricultural operation according to various aspects.

FIG. 6 is a schematic diagram of an exemplary, non-limiting implementation of a computing device according to various aspects.

### DETAILED DESCRIPTION

As described above, an agricultural operation, whether an application operation or a harvesting operation, may involve one or more tendering or pickup operations during execution of the agricultural operation. The one or more tendering or pickup operations may be planned in advance of the agricultural operation. In some instances, for example in variable rate product applications, it is challenging to predict when a tendering operation should occur. When flexibility with possible traversal paths is present, better logistic planning can occur for where tendering operations occur. For example, a plan may be developed to avoid an agricultural machine idly waiting empty for a tender.

An operation planning system and technique are described herein. The planning system obtains various inputs related to an agricultural operation, generates possible paths or plans for the agricultural operation, and evaluates the possible plans or paths generated to select a final plan. The final plan may be communicated to a tender coordinator, an agricultural machine, an operator, or other systems. Further, the planning system can coordinate tender operations and provide guidance for the agricultural machine in accordance with the final plan.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

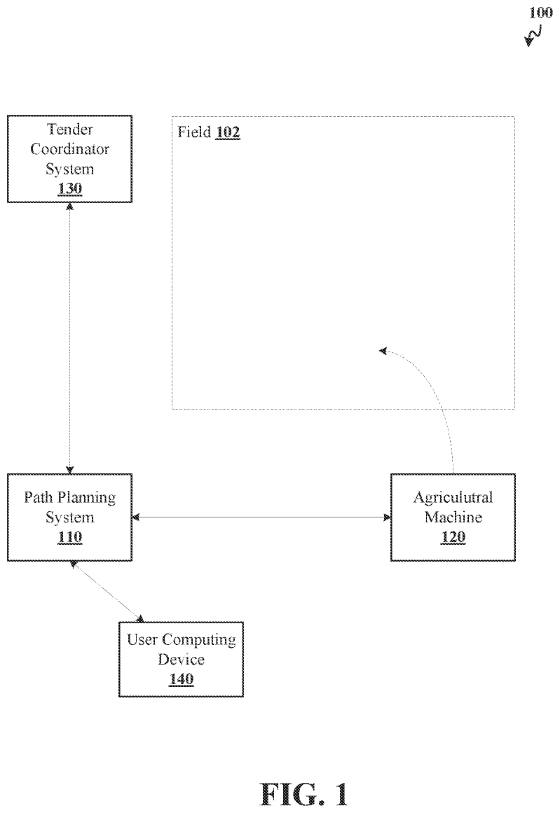

Referring initially to FIG. 1, an exemplary, non-limiting implementation of a planning system 100 for an agricultural operation is illustrated. In an example, the agricultural operation may be an application operation where seed or another product is applied to a field 102 (e.g. field of interest) by an agricultural machine 120. The applied products may include products such as, but not limited to, seed, starter fertilizer, high rate fertilizer, micronutrients, pesticides, herbicides, or biological supplements. In another example, the agricultural operation may be a harvesting operation where a crop is harvested or collected by agricultural machine 120. In general, according to an aspect, the agricultural operation involves material being delivered to (e.g. tendered) and/or collected from the agricultural machine 120 during performance of the agricultural operation.

System 100 includes a path planning system 110 configured to acquire various inputs and output a proposed plan for the agricultural operation. The generated plan may indicate a planned path of agricultural machine 120 through field 102, locations where tender operations (for application operations) or pick-up operations (for harvest operations) occur, associated times for such tender or pick-up operations, products to be delivered for each tender operation, etc. The inputs may include one or more characteristics of the agricultural operation, the agricultural machine 120, field 102, tender operations, prior operations performed, or the like. For example, inputs may include a configuration of the agricultural machine 120 including a tank configuration (e.g. number and size), vehicle speed, etc. In another example, the inputs may include a prescription related to the agricultural operation. The prescription may indicate what product(s) to apply, where to apply the product(s), and how much of the product(s) to apply. Still further, the inputs may include attributes of field 102. The attributes may include a size, a shape, a number and location of refill or tender zones associated with field 102, or the like. Additional inputs received by the path planning system 110 may include a cycle time of tender operations and/or paths taken by machines in prior operations on field 102.

Path planning system 110, based on received inputs, may generate a plurality of potential paths to be taken by agricultural machine 120 when executing the agricultural operation on field 102. According to one example, the plurality of potential paths may be limited based on a crop stage and/or prior operations. For instance, a tilling operation may have little or no restrictions (e.g. greater path flexibility), but a spraying or harvesting operation may be limited by prior tilling or seeding operations (e.g. to avoid crushing existing crop). Further, the received inputs may partially define a potential path. For example, based on projected tender location relative to identified tender zones for field 102, a generate path may not be possible if a projected tender location does not align with a refill zone. In another example, a generated path may not conform with tank configuration of the machine 120 (e.g. requires tendering of product that does not fit in the tanks of machine 120).

In a further aspect, the path planning system 110 evaluates the plurality of potential paths and generates further plan data for each path. The further plan data, for each potential traversal path, may include tendering locations, the products and amounts to be tendered at each location, a time for each tender, etc. The further plan data may be additionally determined based on the inputs received at the path planning system 110.

Path planning system 110 may evaluate the plurality of potential paths and associated plan data to generate score data. Score data may be determined based on various considerations such as, but not limited to, a number of refill locations, a distance to a refill location, a correspondence between refill time and cycle times, a number of tendering operations, a total length of path, amount of time the agricultural machine is turning, crossings of a path over paths of prior operations, etc. By way of example, a particular plan with refill times matching cycle times may have a higher score. In another example, a plan with fewer tender operations may have a higher score than a plan with more tender operations. Still further, path lengths may be a proxy for efficiency. Accordingly, shorter paths may receive a higher score than longer paths. In further examples, paths that reduce an amount of time spent turning may receive a higher score than paths involving more turns.

After evaluation, the plurality of paths or plans can be ranked based on score data. A plan with the highest score may be selected as a final plan and/or presented to user for approval. In another example, it is to be appreciated that the plurality of plans may be presented to the user (in ranked form or unranked) to enable user selection of the final plan.

In yet another aspect, the final plan is communicated to agricultural machine 120, a tender coordinator system 130, and/or a user computing device 140 to facilitate performance of the agricultural operation. In addition to communicating the final plan, the path planning system 110 may actively coordinate execution of the plan. For example, guidance information may be provided to the agricultural machine, notifications may be issued to tender coordinator system 130 to prepare and send a tender, etc. In addition, the path planning system 110 may monitor execution of the plan and generate adjustments. For instance, a position of agricultural machine 120 during the agricultural operation may be monitored. Scheduled times for tender operations may be adjusted based on deviations from projections. In another example, an estimated time to empty may be monitored. Based on this metric, additional tender operations may be added to or removed from the plan during execution.

Although shown as separate components in FIG. 1, it is to be appreciated that the path planning system 110 may be integrated or incorporated into agricultural machine 120, tender coordinate system 130, and/or user computing device 140. In another implementation, path planning system 110 may be cloud-based and communicatively coupled with agricultural machine 120, tender coordinate system 130, and/or user computing device 140. The inputs described above may be manually input by a user via user computing device 140 and/or acquired from tender coordinator system 130 and agricultural machine 120.

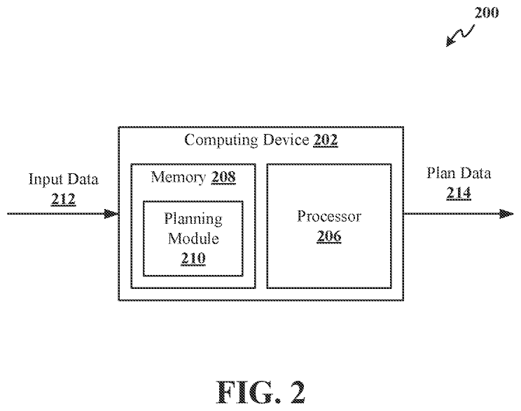

Turning to FIG. 2, an exemplary, non-limiting implementation of a system 200 configured to plan an agricultural operation is illustrated. System 200 includes a computing device 202. In an aspect, path planning system 110 of FIG. 1 may be implemented by computing device 202. As shown in FIG. 2, computing device 202 receives input data 212 and outputs plan data 214. Input data 212 may include various inputs as described above and plan data 214 may include information indicating one or more plans for carrying out the agricultural operation. The plan data 214 may include a traversal path, tendering locations, tendering times, products to be tendered, etc., as described above.

Computing device 202 includes a processor 206 configured to process data and instructions, and provide resulting data based on the processed data and instructions. The computing device 202 further includes a memory 208 (e.g., computer memory, such as a device or system that is used to store information for use in a computer or related computer hardware and digital electronic devices, including short and long-term memory, temporary and permanent memory, and the like). Memory 208 stores executable instructions for planning module 210. Planning module 210, when executed by processor 206, acquires input data 212 and generate plan data 214.

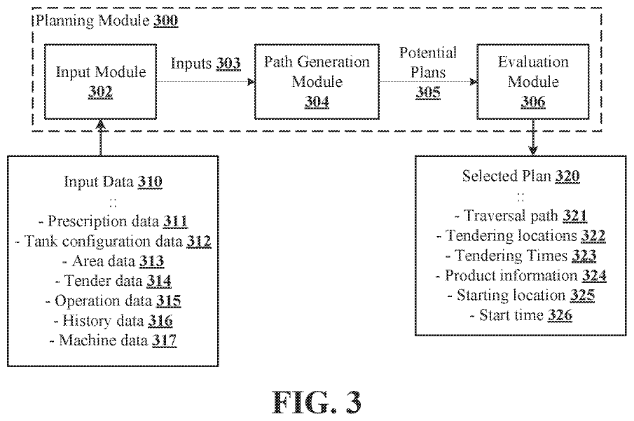

FIG. 3 illustrates a schematic diagram of an exemplary, non-limiting implementation of a planning module 300 in accordance with various aspects. Planning module 300, in an example, may implement planning module 210 of FIG. 2 and/or path planning system 110 of FIG. 1.

Planning module 300 includes functional components implemented with computer-executable instructions that, when executed by a computer processor, carry out the functions described herein. Planning module 300, in an example, includes an input module 302 configured to acquire input data 310 from various sources (e.g. agricultural machines, users, etc.). As shown in FIG. 3, input data 310 may include prescription data 311, tank configuration data 312, area data 313, tender data 314, operation data 315, history data 316, machine 317, and/or other information relevant to planning execution an agricultural operation.

Prescription data 311 may include information indicating, for example, at least one product to be utilized in the agricultural operation, a respective area where the at least one product is utilized, or a respective amount of the at least one product to utilize. The product may include seed, a starter fertilizer, a high rate fertilizer (e.g. nitrogen in the form of dry nitrogen, anhydrous ammonia, liquid fertilizer solutions (28% N, 32% N, 34% N, etc.), or the like), a micronutrient (e.g. zinc, iron, etc.), a pesticide, an herbicide, or a biological supplement. Tank configuration data 312 may include information indicating a configured of tanks of an agricultural machine such as, but not limited to, a number and size of tanks available. Area data 313 may indicate attributes of a field where the agricultural operation is performed. The attributes may include a size of the field, a shape of the field, identification of refill areas for the field, or the like. Tender data 314 may indicate an estimated cycle time for a tender operation. That is, the tender data 314 may indicate how long it takes for a transport vehicle to be filled with product, travel to a tender location, travel back for refill, and return to a next tender location. Operation data 315 may include information indicative of the agricultural operation to be performed. History data 316 may include information indicating previous operation data related to prior agricultural operations performed at the field. Machine 317 may include information indicative of a configuration of the agricultural machine performing the agricultural operation.

Input module 302 collects input 310 and provides inputs 303 to path generation module 304. Path generation module 304 is configured to generate potential paths or plans 305 for the agricultural operation based on the inputs 303. An evaluation module 306 analyzes the potential plans 305 based on a set of criteria to determine a selected plan 320. For example, the evaluation module 306 may rank the potential plans 304 based on a number of refill zones, a distance to a refill zone, a correspondence between refill time and cycle times, a number of tendering operations, a total length of path, amount of time the agricultural machine is turning, or crossings of a path over paths of prior operations. In one implementation, the selected plan 320 may be plan selected from potential plans 305 that is ranked the highest.

The selected plan 320 indicated various aspects such as, but not limited to, a traversal path 321, tendering locations 322, tendering times 323, product information 324, a starting location 325, and a starting time 326. The traversal path 321 may indicate the path to be taken by the agricultural machine. The tendering locations 322, tendering times 323, and the product information 324 indicate locations on or adjacent to the field where tender operations occur, respective times for the tender operations, and the products to be delivered for each tender operation. The starting location 325 is the starting point for the agricultural operation and the starting time 326 is the time at which the operation begins.

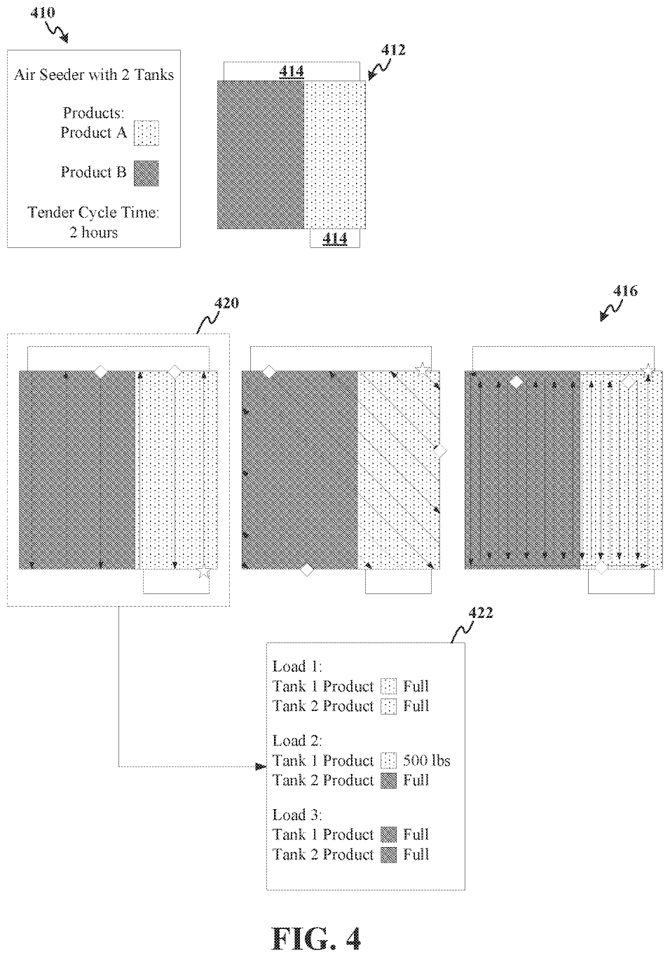

Turning now to FIG. 4, illustrated is a schematic diagram of a non-limiting example of a planning operation according to various aspects. FIG. 4 illustrates path planning using some exemplary inputs to facilitate understanding the planning operation. It is to be appreciated that path planning according to the techniques described herein is not limited to the form and content of the example of FIG. 4.

Inputs to the planning module may include a set of inputs 410, and field attributes and prescription 412. The set of inputs 410 indicate an agricultural machine (e.g. air seeder) having two tanks. In addition, the agricultural operation involves products A and B. A tender cycle time, in this example, is 2 hours. The field attributes 412 indicates a field having a configuration shown in FIG. 4. The field includes refill zones 414. In addition, the field is illustrated according to the prescription to highlight the areas that each product is to be applied.

Based on these inputs, a planning algorithm generates a set of potential paths 416. Each of the paths indicate a starting point (indicated by the star), the travel directions to traverse the field, and the location determined for tender operations (indicated by the diamond shapes). While three potential paths are shown in FIG. 4, it is to be appreciated that the number of paths generated by the algorithm is not so limited and FIG. 4 merely highlights a few examples of paths for descriptive purposes. Among the set of potential paths 416, a selected path or plan 420 may be determined as a final plan. In addition to path indicated, the plan also provides loading information 422 for each projected tender operation. For instance, as shown in FIG. 4, the first load may fill both tanks with product A. In the second load, a first tank is filled with 500 lbs of product A and a second tank is fully filled with product B. In the third load, both tanks are fully filled with product B.

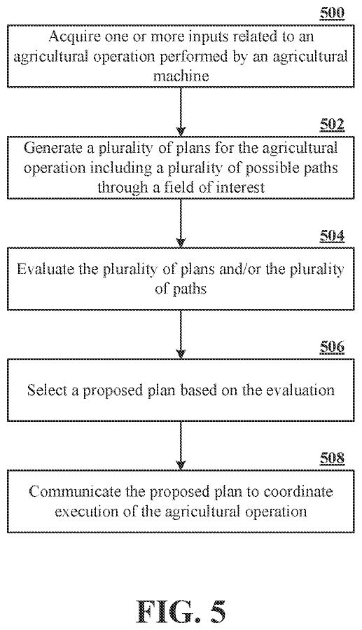

Turning to FIG. 5, various features and operations of the systems and techniques described herein are illustrated with an exemplary flowchart. The example in this figure is illustrative of some features of system 100, system 200, and/or planning module 300, but are not exhaustive. FIG. 5 illustrates a flowchart of a method for planning an agricultural operation. The method of FIG. 5, in some implementations, may be performed by system 100, system 200, planning module 300, agricultural machine 120, and/or other computing device or controller associated with or in communication with the agricultural machine 120.

The method can begin at 500 wherein one or more inputs are acquired. The one or more inputs relate to an agricultural operation performed by an agricultural machine. In an example, the one or more inputs may include a tender cycle time, a prescription, a machine configuration, and/or field attributes. At reference numeral 502, a plurality of plans for the agricultural operation are generated. The plurality of plans may include, for instance, a plurality of possible paths through a field of interest by the agricultural machine. At reference numeral 504, the plurality of paths or the plurality of plans are evaluated based on a set of considerations. Based on the evaluation, at reference numeral 506, a proposed plan is selected. At reference numeral 508, the proposed plan is communicated to the agricultural machine and/or other users to coordinate execution of the agricultural operation.

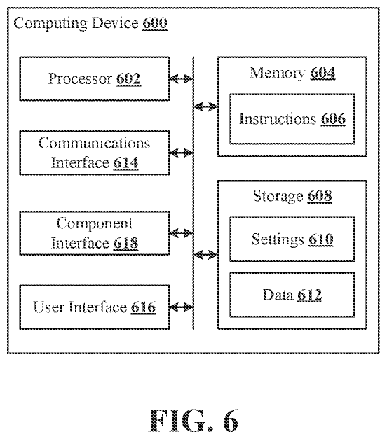

Turning to FIG. 6, illustrated is a schematic block diagram of an exemplary, non-limiting implementation for the computing device 600. Computing device 600 may be utilized to implement path planning system 110, user computing device 140, tender coordinator system 130, computing device 202, or other controller of agricultural machine 120. Computing device 600 includes a processor 602 configured to execute computer-executable instructions 606 such as instructions composing planning module 300. Such computer-executable instructions 606 can be stored on one or more computer-readable media including non-transitory, computer-readable storage media such as memory 604. Memory 604 can also include other data (working data or variables) or portions thereof during execution of instructions 606 by processor 602.

The computing device 600 can also include storage 608 that can be, according to an embodiment, non-volatile storage to persistently store instructions 606, settings 610 and/or data 612.

The computing device 600 may also include a user interface 616 that comprises various elements to obtain user input and to convey user output. For instance, user interface 616 can comprise of a touch display, which operates as both an input device and an output device. In addition, user interface 616 can also include various buttons, switches, keys, etc. by which a user can input information to computing device 600; and other displays, LED indicators, etc. by which other information can be output to the user. Further still, user interface 616 can include input devices such as keyboards, pointing devices, and standalone displays.

The computing device 600 further includes a communications interface 614 to couple computing device 600, via a communications network, to various devices such as, but not limited to, other computing devices 600, tender coordinator system 130, agricultural machine 120, user computing device 140, other controllers, servers, or Internet-enabled devices (e.g., IoT devices). Communication interface 614 can be a wired or wireless interface including, but not limited to, a WiFi interface, an Ethernet interface, a Bluetooth interface, a fiber optic interface, a cellular radio interface, a satellite interface, etc.

A component interface 618 is also provided to couple computing device 600 to various components. Component interface 618 can include a plurality of electrical connections on a circuit board or internal bus of computing device 600 that is further coupled to processor 602, memory 604, etc. Component interface 618, in another embodiment, can be an interface for a CAN bus of agricultural vehicle 120. Further, the component interface 618 can implement various wired or wireless interfaces such as, but not limited to, a USB interface, a serial interface, a WiFi interface, a short-range RF interface (Bluetooth), an infrared interface, a near-field communication (NFC) interface, etc.

According to an aspect, a system for an agricultural machine is provided. The system includes at least one processor. The system also includes a memory that stores instructions. The instructions, when executed by the at least one processor, configure the at least one processor to: acquire input data related to an agricultural operation; generate plan data indicative of a plurality of potential plans for the agricultural machine to perform the agricultural operation; evaluate plan data for each potential plan of the plurality of plans and generate score data; select a final plan from the plurality of potential plans based at least in part on the score data; and communicate final plan data indicative of the final plan to at least the agricultural machine.

In an example, the input data includes prescription data, the prescription data includes information indicative of one or more of at least one product to be utilized in the agricultural operation, a respective area where the at least one product is utilized, or a respective amount of the at least one product to utilize. The at least one product includes one or more of seed, a starter fertilizer, a high rate fertilizer, a micronutrient, a pesticide, an herbicide, a biological supplement.

In another example, the input data includes data indicative of a tank configuration of the agricultural machine. In a further example, the input data includes area data, the area data includes information indicative of attributes of a field where the agricultural operation is performed. The attributes of the field include one or more of a size of the field, a shape of the field, or refill areas for the field.

In another example, the input data includes tender data, the tender data include information indicative of an estimated cycle time for a tender operation. In yet another example, the input data includes previous operation data, the previous operation data includes information indicative of prior agricultural operations performed at a similar location. In another example, the input data further includes machine data, the machine data indicative of a configuration of the agricultural machine.

In an example, plan data for a plan includes information indicative of one or more of a traversal path through a field, a set of tendering locations for tendering operations, corresponding tendering times for the tendering operations, a set of product types and product amounts for the tendering operations, a starting location for the agricultural operation, or a start time for the agricultural operation. In one example, the plan data is evaluated to determine a set of characteristics for respective potential plans, the set of characteristics include one or more of tendering locations relative to identified tendering zones, product amounts relative to machine attributes, or a number of tendering operations. In another example, the plan data is evaluated and the score is generated based on a set of considerations, the set of considerations include one or more of a number of refill zones, a distance to a refill zone, a correspondence between refill time and cycle times, a number of tendering operations, a total length of path, amount of time the agricultural machine is turning, or crossings of a path over paths of prior operations.

In a further example, the instructions further configure the at least one processor to rank the plurality of potential plans based on respective scores. The instructions further configure the at least one processor to select a potential plan from the plurality of potential plans with a highest rank as the final plan.

In yet another example, the agricultural machine provides path guidance to an operator based on the final plan data.

In another aspect, a system for performing an agricultural operation is provided. The system includes an agricultural machine configured to perform the agricultural operation. The system further includes at least one processor. The at least one processor is configured to: receive input data indicative of at least one of a configuration of the agricultural machine, field attributes for a field where the agricultural operation is performed, prior operations performed on the field, product information for the agricultural operation, or tender operation attributes; generate a plurality of potential plans for the agricultural operation based at least in part on the input data; select a final plan from the plurality of potential plans based on an evaluation of a set of features for each potential plan; and communicate the final plan to the agricultural machine. The agricultural machine provides guidance information to an operator based on the final plan.

In an example, the at least one processor is further configured to communicate the final plan to a coordinator of tender operations. In yet another example, the at least one processor is further configured to: receive live data from the agricultural machine while the agricultural machine performs the agricultural operation according to the final plan; determine adjustment data indicative of changes to the final plan based on live data; and communicate updates to the final plan based on the adjustment data.

According to yet another aspect, a method for generating a plan for an agricultural operation is provided. The method includes acquiring, by at least one processor, one or more inputs for the agricultural operation, the inputs include one or more of a tender cycle time, a prescription, a machine configuration, or field attributes. The method also includes generating a plurality of potential paths for an agricultural machine to carry out the agricultural operation. The method further includes evaluating the plurality of potentials paths to select a proposed plan. In addition, the method includes communicating the proposed plan to at least the agricultural machine.

In an example, the method also includes communicating instructions to at least an operator of the agricultural machine and a coordinator of tender operations according to the proposed plan during execution of the agricultural operation.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for path planning have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for path planning. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication.

In summary, various embodiments and examples of systems and methods for path planning have been disclosed. Although the systems and methods for path planning have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

1. A system for an agricultural machine, comprising:
at least one processor; and
a memory that stores instructions that, when executed by the at least one processor, configure the at least one processor to:
acquire input data related to an agricultural operation;
generate plan data indicative of a plurality of potential plans for the agricultural machine to perform the agricultural operation;
evaluate plan data for each potential plan of the plurality of plans and generate score data;
select a final plan from the plurality of potential plans based at least in part on the score data; and
communicate final plan data indicative of the final plan to at least the agricultural machine.

2. The system of claim 1, wherein the input data includes prescription data, the prescription data includes information indicative of one or more of at least one product to be utilized in the agricultural operation, a respective area where the at least one product is utilized, or a respective amount of the at least one product to utilize.

3. The system of claim 2, wherein the at least one product includes one or more of seed, a starter fertilizer, a high rate fertilizer, a micronutrient, a pesticide, an herbicide, a biological supplement.

4. The system of claim 1, wherein the input data includes data indicative of a tank configuration of the agricultural machine.

5. The system of claim 1, wherein the input data includes area data, the area data includes information indicative of attributes of a field where the agricultural operation is performed.

6. The system of claim 5, wherein the attributes of the field include one or more of a size of the field, a shape of the field, or refill areas for the field.

7. The system of claim 1, wherein the input data includes tender data, the tender data include information indicative of an estimated cycle time for a tender operation.

8. The system of claim 1, wherein the input data includes previous operation data, the previous operation data includes information indicative of prior agricultural operations performed at a similar location.

9. The system of claim 1, wherein the input data further includes machine data, the machine data indicative of a configuration of the agricultural machine.

10. The system of claim 1, wherein plan data for a plan includes information indicative of one or more of a traversal path through a field, a set of tendering locations for tendering operations, corresponding tendering times for the tendering operations, a set of product types and product amounts for the tendering operations, a starting location for the agricultural operation, or a start time for the agricultural operation.

11. The system of claim 1, wherein plan data is evaluated to determine a set of characteristics for respective potential plans, the set of characteristics include one or more of tendering locations relative to identified tendering zones, product amounts relative to machine attributes, or a number of tendering operations.

12. The system of claim 1, wherein plan data is evaluated and the score is generated based on a set of considerations, the set of considerations include one or more of a number of refill zones, a distance to a refill zone, a correspondence between refill time and cycle times, a number of tendering operations, a total length of path, amount of time the agricultural machine is turning, or crossings of a path over paths of prior operations.

13. The system of claim 1, wherein the instructions further configure the at least one processor to rank the plurality of potential plans based on respective scores.

14. The system of claim 13, wherein the instructions further configure the at least one processor to select a potential plan from the plurality of potential plans with a highest rank as the final plan.

15. The system of claim 1, wherein the agricultural machine provides path guidance to an operator based on the final plan data.

16. A system for performing an agricultural operation, the system comprising:
an agricultural machine configured to perform the agricultural operation;
at least one processor configured to:
receive input data indicative of at least one of a configuration of the agricultural machine, field attributes for a field where the agricultural operation is performed, prior operations performed on the field, product information for the agricultural operation, or tender operation attributes;
generate a plurality of potential plans for the agricultural operation based at least in part on the input data;
select a final plan from the plurality of potential plans based on an evaluation of a set of features for each potential plan; and
communicate the final plan to the agricultural machine,
wherein the agricultural machine provides guidance information to an operator based on the final plan.

17. The system of claim 16, wherein the at least one processor is further configured to communicate the final plan to a coordinator of tender operations

18. The system of claim 16, wherein the at least one processor is further configured to:
receive live data from the agricultural machine while the agricultural machine performs the agricultural operation according to the final plan;
determine adjustment data indicative of changes to the final plan based on live data; and
communicate updates to the final plan based on the adjustment data.

19. A method for generating a plan for an agricultural operation, the method comprising:
acquiring, by at least one processor, one or more inputs for the agricultural operation, the inputs include one or more of a tender cycle time, a prescription, a machine configuration, or field attributes;
generating a plurality of potential paths for an agricultural machine to carry out the agricultural operation;
evaluating the plurality of potentials paths to select a proposed plan; and
communicating the proposed plan to at least the agricultural machine.

20. The method of claim 19, further comprising communicating instructions to at least an operator of the agricultural machine and a coordinator of tender operations according to the proposed plan during execution of the agricultural operation.
